(19) United States
(12) Patent Application Publication
(10) Pub. No.: US 2017/0175626 A1
(43) Pub. Date: Jun. 22, 2017

(54) GAS TURBINE ENGINE WITH MINIMIZED INLET DISTORTION

(71) Applicant: United Technologies Corporation, Farmington, CT (US)

(72) Inventors: Yuan J. Qiu, Glastonbury, CT (US); Amr Ali, South Windsor, CT (US); Steven H. Zysman, Amston, CT (US)

(21) Appl. No.: 14/974,112

(22) Filed: Dec. 18, 2015

(51) Int. Cl. F02C 7/04; F02K 3/06; F04D 29/38; F04D 29/52; F02C 3/04; F04D 19/00

(52) U.S. Cl. CPC F02C 7/04; F02C 3/04; F04D 19/002; F04D 29/384; F04D 29/522; F02K 3/06; F05D 2220/32; F05D 2240/30

(57) ABSTRACT

A gas turbine engine comprises a nacelle and a fan rotor carrying a plurality of fan blades. The nacelle is formed with droop such that one portion extends axially further from the fan blades than does another portion. The nacelle has inner periphery that is substantially axially symmetric about a center axis of the rotor from either a throat of the nacelle at a substantially bottom dead center location, or a point of inflection at which the inner periphery of the nacelle at substantially bottom dead center merges a convex portion into a concave portion.

### BACKGROUND OF THE INVENTION

This application relates to a gas turbine engine having minimized inlet distortion.

Gas turbine engines are known and typically include a fan delivering air into a bypass duct as propulsion air and into a compressor as core flow. The air is compressed in the compressor and delivered into a combustor where it is mixed with fuel and ignited. Products of this combustion pass downstream over turbine rotors, driving them to rotate.

Recently, a gear reduction has been incorporated between a fan drive turbine and the fan rotor. This has increased the design freedom for the gas turbine engine designer. In particular, the fan can now be made to rotate slower than the turbine. With this change, the diameter of the fan has increased.

It has recently been proposed to provide a gas turbine engine, where the inlet or area of a surrounding housing or nacelle forward of the fan rotor, is shorter than in the past. Providing a shorter inlet reduces the weight of the engine and also reduces external drag. Other benefits include reducing a bending moment and corresponding load on an engine structure during flight conditions such as takeoff. Further, by making the inlet shorter, the overall envelope of the engine is reduced.

However, the shorter inlets raise various challenges including a decreased ability to attenuate noise generated by the engine.

### SUMMARY OF THE INVENTION

In a featured embodiment, a gas turbine engine comprises a nacelle and a fan rotor carrying a plurality of fan blades. The nacelle is formed with droop such that one portion extends axially further from the fan blades than does another portion. The nacelle has inner periphery that is substantially axially symmetric about a center axis of the rotor from either a throat of the nacelle at a substantially bottom dead center location, or a point of inflection at which the inner periphery of the nacelle at substantially bottom dead center merges a convex portion into a concave portion. In another embodiment according to the previous embodiment, a first distance may be defined from outermost edges of the fan blades to a plane extending through the throat or the point of inflection. The plane is defined perpendicular to the center axis, and the axially symmetric surface are formed over between 110% and 90% of the first distance.

In another embodiment according to any of the previous embodiments, axial symmetry is defined as being within a manufacturing tolerance.

In another embodiment according to any of the previous embodiments, the manufacturing tolerance is +/−0.1 inch (0.254 centimeters).

In another embodiment according to any of the previous embodiments, the axially symmetric surface occurs over at least 350° of a circumference of the nacelle defined about the center axis.

In another embodiment according to any of the previous embodiments, a second distance is defined from a plane defined by leading edges of the fan blades to an axial location of a forwardmost part of the nacelle, an outer diameter of the fan blades is defined, and a ratio of the distance to the outer diameter is between about 0.2 and about 0.5.

In another embodiment according to any of the previous embodiments, the ratio is greater than about 0.25.

In another embodiment according to any of the previous embodiments, the ratio is greater than about 0.30.

In another embodiment according to any of the previous embodiments, the ratio is less than about 0.40.

In another embodiment according to any of the previous embodiments, the second distance measured to the one portion of the nacelle still results in a ratio less than about 0.45, and the second distance being measured to the other portion of the nacelle still results in the ratio being greater than about 0.2.

In another embodiment according to any of the previous embodiments, axial symmetry is defined as being within a manufacturing tolerance.

In another embodiment according to any of the previous embodiments, the manufacturing tolerance is +/−0.1 inch (0.254 centimeters).

In another embodiment according to any of the previous embodiments, the axially symmetric surface occurs over at least 350° of a circumference of the nacelle defined about the center axis.

In another embodiment according to any of the previous embodiments, a second distance is defined from a plane defined by leading edges of the fan blades to an axial location of a forwardmost part of the nacelle, an outer diameter of the fan blades is defined, and a ratio of the distance to the outer diameter is between about 0.2 and about 0.5.

In another embodiment according to any of the previous embodiments, the second distance measured to the one portion of the nacelle still results in a ratio less than about 0.45, and the second distance being measured to the other portion of the nacelle still results in the ratio being greater than about 0.2.

In another embodiment according to any of the previous embodiments, a fan drive turbine drives the fan rotor through a gear reduction.

In another embodiment according to any of the previous embodiments, a gear ratio of the gear reduction is greater than about 2.3.

In another embodiment according to any of the previous embodiments, a pressure ratio across the fan drive turbine is greater than about 5.

In another embodiment according to any of the previous embodiments, a pressure ratio across the fan drive turbine is greater than about 5.

In another embodiment according to any of the previous embodiments, the fan rotor delivers air into a bypass duct a bypass air, and into a core engine including a compressor, and a bypass ratio is defined as the volume of air being delivered into the bypass duct to the volume of air delivered into the core engine, with the bypass ratio being greater than about 6.

These and other features may be best understood from the following drawings and specification.

### BRIEF DESCRIPTION OF THE DRAWINGS

FIG. 1 schematically shows an embodiment of a gas turbine engine.

FIG. 2 shows a challenge in short inlet engines.

FIG. 3 shows a first embodiment.

### DETAILED DESCRIPTION

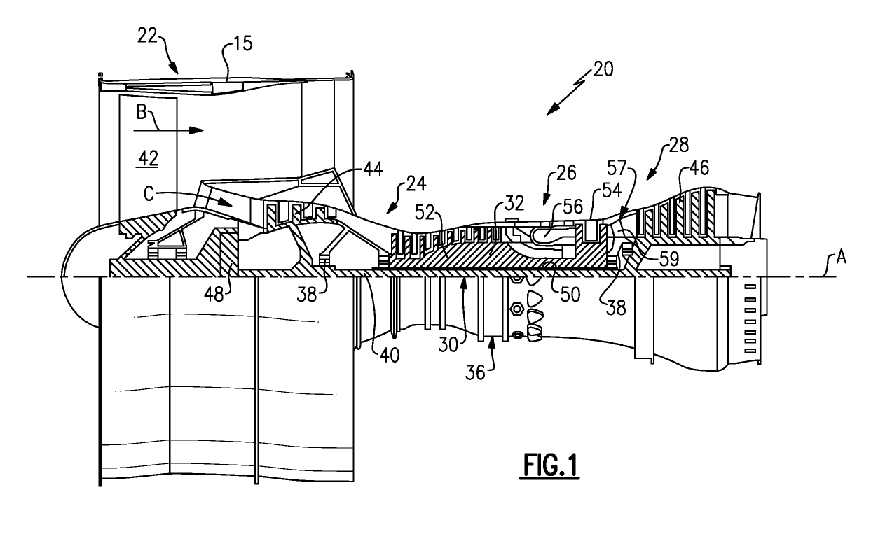

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFCT’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7 °R)]⁵. The “Low corrected fan tip speed” as disclosed herein according to one non-limiting embodiment is less than about 1150 ft/second (350.5 meters/second).

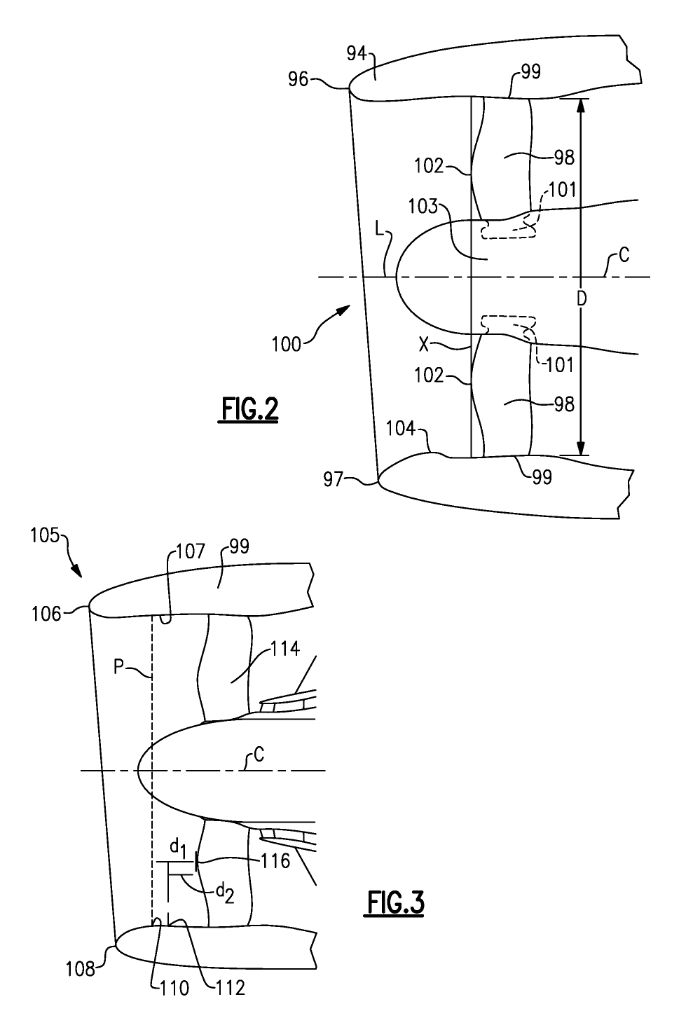

FIG. 2 shows an engine 100 known as a short inlet engine. As shown, a nacelle 94 has forwardmost ends 96 and 97. As can be seen, the forwardmost ends do not necessarily lie in a common plane perpendicular to a center axis of the engine. Rather, point 96 is further forward than point 97. Fan blades 98 have an outer diameter 99. The nacelle 94 is shown to have a radially inwardly extending innermost point 104. Point 104 is radially inward of the outer diameter 99 of the fan blade 98. As shown schematically, the fan blades 98 have a root section 101 received in a hub 103 of the fan rotor. Due to the radially innermost point 104, and the mounting of the blade, it could be difficult to remove a fan blade 98 from the engine.

The short inlet may be defined by a distance L measured from: (a) a plane X perpendicular to a central axis C, which plane also being tangent to a leading edge or forwardmost point 102 of the fan blade 98 to (b) a plane defined by the forwardmost points (including ends 96, 97) of the nacelle 94. A ratio is defined of L:D with D being the outer diameter of the fan blades 98.

In one embodiment L:D is between about 0.2 and about 0.45. Alternatively, the ratio may be greater than about 0.25 and in alternative embodiments greater than about 0.30. In embodiments, the ratio of L:D may be less than about 0.40.

As can be appreciated, the L:D quantity would be different if measured to the forwardmost point 96 than to the forwardmost point 97. However, in embodiments the ratio at the forwardmost point 96 would still be less than about 0.45, and the ratio at the shortest forwardmost point 97 would still be greater than about 0.2. Of course, engines where the entire circumference does not come within this range may also come within the scope of this disclosure.

Stated another way, the forwardmost end of the nacelle 94 extends outwardly for varying extents across the circumference of the nacelle, and the ratio of the L:D for all portions of the varying distance of the nacelle being between about 0.2 and about 0.45.

The several embodiments provide the benefits of the short inlet and allow freedom of design of the inner periphery of the nacelle, while still facilitating removal of the fan blade.

FIG. 3 shows an engine embodiment 105 having a nacelle 99. The different distances to the forwardmost ends 106 and 108 result in a nacelle configuration having a feature called “droop.” Within a nacelle having droop, certain contouring of the inner periphery is required that is different at the points 106 and 108. It should be understood that this is also true at locations circumferentially between the two points, and the points 106 and 108 are the extreme forwardmost and extreme rearwardmost locations. Generally, the rearwardmost location 108 will be at 6:00 o'clock, or substantially bottom dead center when the engine is mounted on an aircraft.

It is generally desirable to have an axially symmetric surface at the inner periphery 107. However, this cannot be over the entirety of the surface given requirements of a nacelle having droop. Still, to minimize the amount of distortion for air heading into the inlet and toward the fan blades 114, the axially symmetric surfaces are maintained over as great a portion of the axial length as is possible. That plane marks the beginning of the axially symmetric surfaces. The plane P is perpendicular to the center axis C, and passes through the throat 110 of the nacelle at substantially bottom dead center. That is, this is the radially smallest location 110 for the nacelle at the substantially bottom dead center measured from the center axis C. After passing this point, the axially symmetric surfaces begin. In an alternative, the beginning of the axially symmetric surface is at a point of inflection 112 at substantially bottom dead center. Generally, the point of inflection is defined as when a convex surface merges into as concave surface. While it is desirable that the axially symmetric surface begins at the point 110 or 112, a dimension d1 or d2 can be defined from the forwardmost or leading edge 116 of the fan blade 114 to the plane P, or to a similar plane that would pass through the point of inflection 112. In embodiments, the beginning of the axially symmetric surface covers between 90% and 110% of the distance d1 or d2. Of course, the locations may be a bit removed but are taken at substantially (+/−)10° bottom dead center.

The axial symmetric surface can be defined as having the entire surface (across its circumference) being symmetric at any axial point within a tolerance of +/−0.1 inch (0.254 centimeters).

Another alternative way of describing the axially symmetric surface is that the axial symmetry would occur over at least 350° about the center axis C. That is, there may be localized components mounted over a very limited circumferential extent within the inner periphery 107 that move away from the symmetric surface by an amount greater than +/−0.1 inch (0.254 centimeters).

By including the axially symmetric surface over such a great portion of the nacelle 94, the inlet distortion is reduced dramatically.

Although embodiments have been disclosed, a worker of ordinary skill in this art would recognize that certain modifications would come within the scope of this disclosure. For that reason, the following claims should be studied to determine the true scope and content of this invention.

1. A gas turbine engine comprising:
a nacelle and a fan rotor carrying a plurality of fan blades, said nacelle being formed with droop such that one portion extends axially further from said fan blades than does another portion, and said nacelle having inner periphery that is substantially axially symmetric about a center axis of the rotor from either a throat of the nacelle at a bottom dead center location, or a point of inflection at which the inner periphery of the nacelle at substantially bottom dead center merges a convex portion into a concave portion.

2. The gas turbine engine as set forth in claim 1, wherein a first distance may be defined from outermost edges of said fan blades to a plane extending through said throat or said point of inflection, said plane being defined perpendicular to said center axis, and said axially symmetric surface being formed over between 110% and 90% of said first distance.

3. The gas turbine engine as set forth in claim 2, wherein axial symmetry being defined as being within a manufacturing tolerance.

4. The gas turbine engine as set forth in claim 3, wherein said manufacturing tolerance is +/−0.1 inch (0.254 centimeters).

5. The gas turbine engine as set forth in claim 3, wherein said axially symmetric surface occurs over at least 350° of a circumference of said nacelle defined about said center axis.

6. The gas turbine engine as set forth in claim 5, wherein a second distance is defined from a plane defined by leading edges of said fan blades to an axial location of a forwardmost part of said nacelle, and an outer diameter of said fan blades being defined, and a ratio of said distance to said outer diameter is between about 0.2 and about 0.5.

7. The gas turbine engine as set forth in claim 6, wherein said ratio being greater than about 0.25.

8. The gas turbine engine as set forth in claim 7, wherein said ratio is greater than about 0.30.

9. The gas turbine engine as set forth in claim 7, wherein said ratio is less than about 0.40.

10. The gas turbine engine as set forth in claim 6, wherein the second distance measured to the one portion of said nacelle still results in a ratio less than about 0.45, and the second distance being measured to the other portion of said nacelle still results in said ratio being greater than about 0.2.

11. The gas turbine engine as set forth in claim 1, wherein axial symmetry being defined as being within a manufacturing tolerance.

12. The gas turbine engine as set forth in claim 11, wherein said manufacturing tolerance is +/−0.1 inch (0.254 centimeters).

13. The gas turbine engine as set forth in claim 1, wherein said axially symmetric surface occurs over at least 350° of a circumference of said nacelle defined about said center axis.

14. The gas turbine engine as set forth in claim 1, wherein a second distance is defined from a plane defined by leading edges of said fan blades to an axial location of a forwardmost part of said nacelle, and an outer diameter of said fan blades being defined, and a ratio of said distance to said outer diameter is between about 0.2 and about 0.5

15. The gas turbine engine as set forth in claim 14, wherein the second distance measured to the one portion of said nacelle still results in a ratio less than about 0.45, and the second distance being measured to the other portion of said nacelle still results in said ratio being greater than about 0.2.

16. The gas turbine engine as set forth in claim 1, wherein a fan drive turbine driving said fan rotor through a gear reduction.

17. The gas turbine engine as set forth in claim 16, wherein a gear ratio of said gear reduction being greater than about 2.3.

18. The gas turbine engine as set forth in claim 17, wherein a pressure ratio across said fan drive turbine being greater than about 5.

19. The gas turbine engine as set forth in claim 16, wherein a pressure ratio across said fan drive turbine being greater than about 5.

20. The gas turbine engine as set forth in claim 1, wherein said fan rotor delivering air into a bypass duct a bypass air, and into a core engine including a compressor, and a bypass ratio being defined as the volume of air being delivered into said bypass duct to the volume of air delivered into said core engine, with said bypass ratio being greater than about 6.
